(19) United States
(12) Patent Application Publication
(10) Pub. No.: US 2014/0375448 A1
(43) Pub. Date: Dec. 25, 2014

(54) VARIABLE BRAKE LIGHT CONTROL SYSTEM USING USER TERMINAL, AND METHOD FOR CONTROLLING THE SAME

(71) Applicant: Jun Seok Lee, Seoul (KR)

(72) Inventor: Jun Seok Lee, Seoul (KR)

(21) Appl. No.: 14/376,369

(22) PCT Filed: Feb. 9, 2012
(86) PCT No.: PCT/KR2012/000966

§ 371 Date: Aug. 4, 2014

(30) Foreign Application Priority Data
Feb. 6, 2012 (KR) 10-2012-0011971

(51) Int. Cl. B60Q 1/44

(52) U.S. Cl. CPC B60Q 1/444; B60Q 1/441
USPC 340/479

(57) ABSTRACT

The present invention relates to a variable brake light in which a lighting unit can be illuminated in a variety of shapes according to a vehicle operating state or the selection of a driver. The variable brake light comprises: a lighting unit consisting of LED lamps in which a plurality of LEDs are arranged in a brake light according to a specific pattern so as to display designs having various shapes or patterns; a user terminal in which an application program is installed, comprising pattern input means for inputting a brake light pattern using the installed application program, and which transmits the input pattern information to the brake light through wireless communication means; and a brake light control device for receiving the pattern information from the user terminal through the wireless communication means, generating a control signal for controlling flashing of each LED lamp of the lighting unit according to the received pattern information, and transmitting the control signal to the lighting unit.

### BACKGROUND OF THE INVENTION

1. Field of the Invention

The present invention relates to a brake light control system and method for controlling the same, and more particularly to a variable brake light control system using user terminal in which the lighting unit of brake light of the corresponding vehicle can be illuminated in a variety of shapes according to an input of lighting pattern of a brake light via user terminal and method for controlling the variable brake light control system.

2. Description of the Prior Art

In general, the brake light of vehicle has function that informs the driver of the following up vehicle that a brake pedal is pressed by lighting on of the brake light when the operator operate brake.

For this purpose, the brake light control apparatus is composed of a lighting unit which is installed in the rear of the vehicle, and a detection switch which is connected to the brake pedal of vehicle and operated with on when the driver pressing it. Therefore, when the driver is stepping the brake pedal, the detection switch is on so that the said lighting unit is powered and light.

At this time, the said lighting unit is consisted of the LED lamp which a normal light bulb or a plurality of light emitting diodes (Light Emitting Diode; LED) is integrated. On the other hand, in recent years, as illustrated in FIG. 1, it has been configured that the on-vehicle control unit (3) apply power to lighting unit (1) by using ETACS (Electronic Timing and Alarm Control System) when the detection switch (2) is on.

By the way, such brake light carry out a simple function that it is cn when the driver is stepping the brake pedal and it is off when the driver does not stepping the brake pedal, so that it has monotonous feeling. Furthermore, there is problem that, when an emergency occurs substantially, it is difficult for the driver of the follow-up vehicle to recognize the situation accurately.

In particular, in case that the tail light is turned on at night, the brake lights light is also on thin with one step. Therefore, it may be occurred problem that it is difficult to distinguish exactly the state in case of that the brake lights are lit by stepping the brake pedal and the state in case of that the rear light is lit.

Also, the conventional brake light is lit on or off with a regular shape of brake light according to a kinds of the vehicle having a specific configuration at vehicle design, and offer only the difference in brightness with the same type. Thus, it has been required to provide a method that can give various effects by displaying the brake light with various forms, design or patterns according to the control of the user, or according to various situations.

### SUMMARY OF THE INVENTION

The object of the invention is to provide a variable brake light control system using user terminal that allows to display the designs or patterns of various forms that the drivers desire at the brake light of the vehicle, and a control method thereof.

Also, another object of the present invention is to provide a variable brake light control system using user terminal that makes it possible to display the input pattern by reflecting it in real time at the brake light of the corresponding linked vehicle in accordance with the inputted pattern by inputting the pattern when lighting the brake light through application program being installed in the user terminal, and a control method thereof.

The above object of the present invention and the various advantages will become more apparent from the preferred embodiment of the present invention by those skilled in the art.

### Technical Solution

The characteristic configuration of the present invention to achieve the object of the present invention as being described above and the peculiar effect of the present invention as being described hereinafter, is as the following.

According to one aspect of the present invention, a variable brake light control system using user terminal is the brake light control system of vehicle which comprises a lighting unit of a brake light being installed on the rear of the vehicle and a detection switch which is connected to the brake pedal and is on when the driver stepping the brake pedal, wherein it comprises the lighting unit which is consisted of the LED lamp being consisted by disposing a plurality of LED in accordance with a particular pattern in the said brake light to display a certain design or shape of various forms or patterns; the user terminal which application program is installed, and a pattern inputting means is provides that can enter the patterns of the brake light by the said installed application program, and then the inputted pattern information of the brake light is transferred via the wireless communication means; and the brake lights control device which receive the said pattern information from the said user terminal via a wireless communication means, and then generate a control signal which can control an on-off of each LED lamp of the said lighting unit based on the said received pattern information to transmit it to the said lighting unit.

Preferably, it is characterized in that the said user terminal communicates with the brake lights control device in accordance with the execution of the said application program, and receives information of the vehicle from the said the brake lights control device, and then synchronizes it.

Preferably, it is characterized in that the said brake light control device comprises the GPS which outputs the information such as position, velocity or acceleration of the vehicle.

Preferably, it is characterized in that the said brake light control device is further provided measurement sensor for measuring the speed or pressure that the driver stepped on the brake pedal.

According to another aspect of the invention, the method for controlling a variable brake light using user terminal is as the method for controlling a brake light of vehicle by a brake light control system for vehicle which comprises a lighting unit of a brake light being installed on the rear of the vehicle and a detection switch which is connected to the brake pedal and is on when the driver stepping the brake pedal, wherein it comprises steps of providing a pattern inputting means which is capable enter the patterns of the brake light by the application program installed in the user terminal; transferring the pattern information of the brake light being inputted through the said pattern inputting means to the brake lights control device being installed into the vehicle via wireless communication means; receiving the said pattern information for the said brake lights control device form the said user terminal via wireless communication means, and generating a control signal which can control an on-off of each LED lamp of the said lighting unit based on the said received pattern information; transferring the said control signal being generated form the said brake lights control device to the lighting unit; and being a plurality of LED of to said the lighting unit on-off to the corresponding patterns in accordance with the said control signal.

Preferably, it is characterized in that the said method further comprises step that the said user terminal communicates with the brake lights control device in accordance with the execution of the said application program, and receives information of the vehicle from the said the brake lights control device, and then synchronizes it.

Preferably, it is characterized in that the said brake light control device comprises the GPS which outputs the information such as position, velocity or acceleration of the vehicle.

Preferably, it is characterized in that the said brake light control device is further provided measurement sensor for measuring the speed or pressure that the driver stepped on the brake pedal.

### Effect of the Invention

As being described above, according to the present invention, once the driver input the selected signal using the selecting means (10), the control unit (20) output the designs or color of the shape or patterns that the driver selects to the lighting unit (1) to light it based on the designs or color of the shape or patterns that the driver selects, so that there is advantageous that the followed driver can recognize that the brake right is lit certainly, and also it provides new feeling.

Also, according to the present invention, it has advantage that can display various types of information beyond a simple function of on-off in the prior brake light by inputting the driver optionally the designs or color of the shape or patterns which will be displayed on the brake light of his own vehicle using his own smart phone and the like, and then being on-off it in accordance with the inputted form in real time.

Further, the present invention has advantage that can easily notice dangerous situations or information that the user wants to inform through the brake light to the followed driver by reflecting the patterns of the brake light that the user wants in real-time.

### BRIEF DESCRIPTION OF THE DRAWINGS

The variable brake light control system according to the present invention will now be described by way of example only, with reference to the accompanying drawings, in which:

FIG. 1 is a block diagram illustrating a conventional brake light;

FIG. 2 is a block diagram illustrating a first embodiment of a variable brake light according to the present invention;

FIG. 3 is a block diagram illustrating a second embodiment of a variable brake light according to the present invention;

FIG. 4 is a block diagram illustrating a third embodiment of a variable brake light according to the present invention;

FIG. 5 is a drawing illustrating a variable brake light control system using user terminal according to example of the present invention;

FIG. 6 is a drawing illustrating a detailed configuration of the brake light control device according to example of the present invention;

FIG. 7 is a flowchart showing the procedure for controlling a variable brake light using user terminal according to example of the present invention;

FIGS. 8 and 9 are the drawings showing the brake light pattern inputting image at the smart phone according to example of the present invention;

FIG. 10 is a drawing showing the vehicle rear portion which the pattern inputted via the smart phone is displayed on the brake light according to example of the present invention.

### BEST MODE FOR CARRYING OUT THE INVENTION

A detailed description of the present invention described below will be described by way of specific embodiments which the present invention may be implemented, with reference to the accompanying drawings. These embodiments are described in detail sufficient to carry out by one skilled in the art. It should be understood that it is not necessary to exclude each other even though various embodiments of the present invention are mutually different. For example, the particular shape, structure and characteristics described herein may be implemented in another embodiment in the context of an exemplary embodiment without departing from the spirit and scope of the present invention. In addition, it should be understood that the location or arrangement of individual components of the disclosed each embodiments of the invention may be changed or modified without departing from the spirit and scope of the present invention. Accordingly, the following detailed description is not intended to be taken as limiting sense, and the scope of the present invention is suitably as described in the claims, then the claims are all equal with a range limited only by the appended claims. In the drawing, the similar reference characters designate the same or similar functionality throughout the several aspects.

The present invention proposes a variable brake light control system using user terminal which makes it possible to display the designs or patterns of various shapes being desired by the driver on the brake light and method for controlling the said variable brake light control system. In particular, according to an embodiment of the invention, once the user inputs the patterns illumination at the brake light through an application program installed in a user terminal such as a smart phone, the brake light of the corresponding linked vehicle may be displayed the image according to the said inputted patterns with reflecting it in real-time.

On the other hand, even though the mobile terminal such as “smart phone” and the like is exemplified as a user terminal of the present invention at the following detailed description, but the present invention can be applied any terminal which can provide the typical function according to the present invention, as well as the said smart phones, a representative one of a mobile terminal. For example, a user terminal can be applied to all the user terminals which can execute applications including the fixed terminal such as a desktop computer, TV, and the like, as well as a mobile terminals such as a smart phone, a laptop computer, a digital broadcasting terminals, PDA (Personal Digital Assistants), PMP (Portable Multimedia Player) and navigation devices, and is preferably applied a terminal that can be connected to at least one wired or wireless network.

Hereinafter, the present invention will be described in detail below regarding the preferred embodiments with reference to the accompanying drawings to make it possible to carry out the present invention by the skilled person in the art of the present invention.

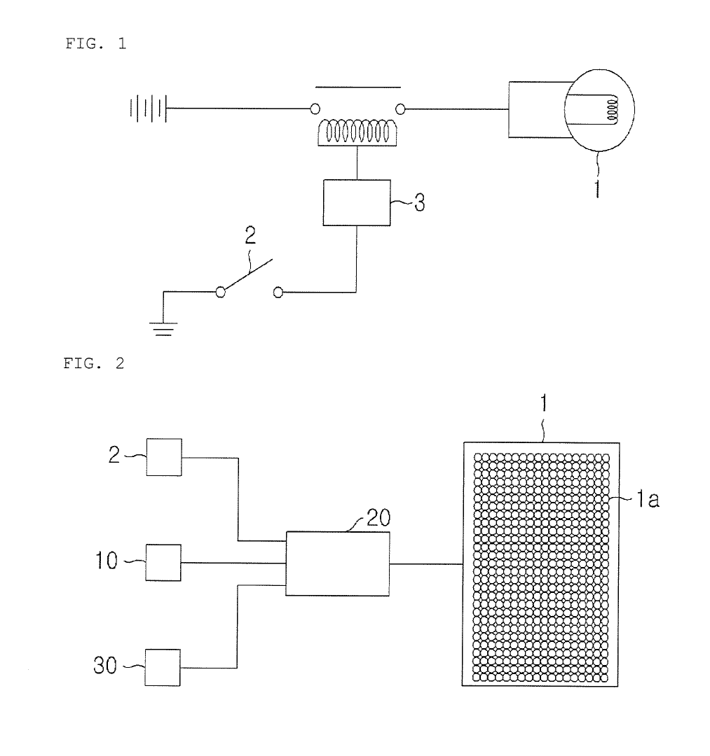

First, the apparatus for controlling a variable brake light in accordance with the present invention is described with reference to FIGS. 2 to 4.

FIG. 2 illustrates the variable brake light control apparatus in accordance with the present invention. This variable brake light control apparatus being installed in the vehicle is same with the conventional one in that it comprises lighting unit (1) being installed in the rear of the vehicle, and the detection switch (2) which is connected to the brake pedal of the vehicle and is illuminated when the driver stepping the brake pedal.

And, according to the present invention, the said lighting unit (1) is configured such that it can display the various types of pattern, and it further comprises a control unit (20) which control to output a preset design or color of a shape and a pattern on the said lighting unit (1) and display it, a selection means (10) which output a selection signal which select design or color of a shape and a pattern to be outputted on the said control unit (20), and measurement sensor (30) for measuring the speed or pressure which the driver stepped on the brake pedal.

The said lighting unit (1) is composed of an LED lamp made of a plurality of LED (la) arranged according to a specific pattern, and configured such that once the said control unit (20) outputs the data of a particular design or pattern, it receives and displays the data of a particular design or pattern. For this, it is preferable that the said LED lamps are obtained by arranging LED (la) more densely comparison with a LED lamp used at the general vehicle brake light. As required, it is also possible to express various colors together with a variety of patterns or designs by mixing various colors LED (la).

The said control unit (20) may use the ECU provided in the engine of the vehicle, the control unit provided in the ETACS (Electronic Timing and Alarm Control System) 20 or the exclusive control unit constructed separately. The said control unit (20) can store the data of a various design or pattern, and outputs the selected patterns or designs to the said lighting unit (1) if the driver selects the patterns or designs by using the said selection means (10), and then steps the brake pedal to turn on the detection switch (2). At this time, the designs or the patterns being stored in the said control unit (20) may include the diagram such as heart, triangular, square or various other shapes, or characters or symbols and the like. In addition, the said control unit (20) can be constructed such that it can adjust the brightness of the said lighting unit (1) through PWM duty control.

The said selection means (10) may use a common dial type selection switch or button type selection switch which a plurality of button is provided so that the driver can select by pressing a desired button.

The said measurement sensor (30) is connected to the brake pedal or the brake cylinder so that it measures the brake pedal stepping velocity and pressure and outputs the measured data to the said control unit (20).

Therefore, once the driver step on the brake pedal to turn on detection switch (2) in the state of selecting one among the designs or the patterns being stored in the said control unit (20) by operating the said selection switch, the said control unit (20) outputs the data of selected designs or patterns to the said lighting unit (1), and the said lighting unit (1) turn on the LED according to the received designs or patterns. In other words, if the driver selects the design of heart, the lighting unit (1) is lit with the form of heart; and if the driver selects the design of triangle or square, or other types of designs and patterns, the lighting unit (1) is lit with the form of the selected designs or patterns. At this time, the said control unit (20) adjusts the brightness of the lighting unit (1) with receiving the data being outputted from the said measurement sensor (30). In other words, if the velocity or the pressure that the driver is stepping on the brake pedal increases, the lighting unit (1) is also more brightly lit.

And, when the rear light is lit, the lighting unit (1) is turned on a whole uniformly as the conventional lighting unit (1), and it should be illuminated with the selected form of the designs or patterns only when the driver step the brake pedal. In case of vehicle that the rear light and the lighting unit (1) being on only when the brake pedal is stepped are provided separately, the said rear light may be turned of/off with a general method, and only the said lighting unit (1) may be lit with the above mentioned method.

Since such variable brake light is turned of at the lighting unit (1) with the selected form of the designs or patterns when the driver selects his desired designs or patterns and steps the brake pedal, it has advantage that it can offer various effects and call the followed driver's attention contrary to conventional monotonous brake lights which can not select the shape that the lighting unit (1) is lit. In particular, since the lighting shapes are different between when the rear light is on simply and when the light unit (1) is turned by stepping the brake pedal, the followed driver can definitely distinguish between the states that the rear light is on and the states that the light unit (1) is turned by stepping the brake pedal, so that it can be effectively prevented from being generated a collision accident which may be occurred when the followed driver can not recognize a stop of the front car.

In addition, since the brightness of the brake light can be controlled according to velocity or the pressure that the driver is stepping on the brake pedal, the driver of the following vehicle can definitely recognize sudden stop of the front car depending on the brightness of the brake light so that a collision accident can be effectively prevented.

In the present embodiment, even though it is exemplified that the said lighting unit (1) is consisted of LED lamp which is formed by disposing a plurality of LED according to particular pattern, anything that can display designs or patterns being outputted from the said control unit (20), including LCD, AMOLED, TFT-LCD, can be used.
In addition, it is possible to enable the control unit (20) to output the data of designs or patterns being selected by the driver to the lighting unit (1) in case of a general stop or slow down situation, and to output the preset emergency signal to the lighting unit (1) in case of sudden stop or rapid deceleration situation.

In addition, with providing the communication port such as a USB port at the said control unit (20), it is possible to display the driver's desired designs or patterns to the said lighting unit (1) by inputting a certain data of designs or patterns into the control unit (20) via the communication port.

And, the aforementioned designs or patterns may include the pattern that makes the lamp to be flashed or stripe to be moved to lateral direction other then the simple shape.

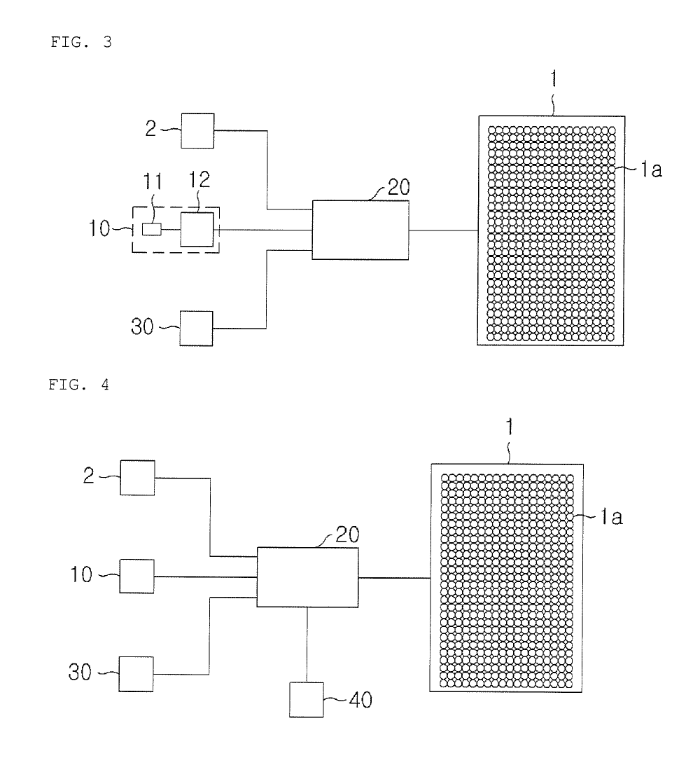

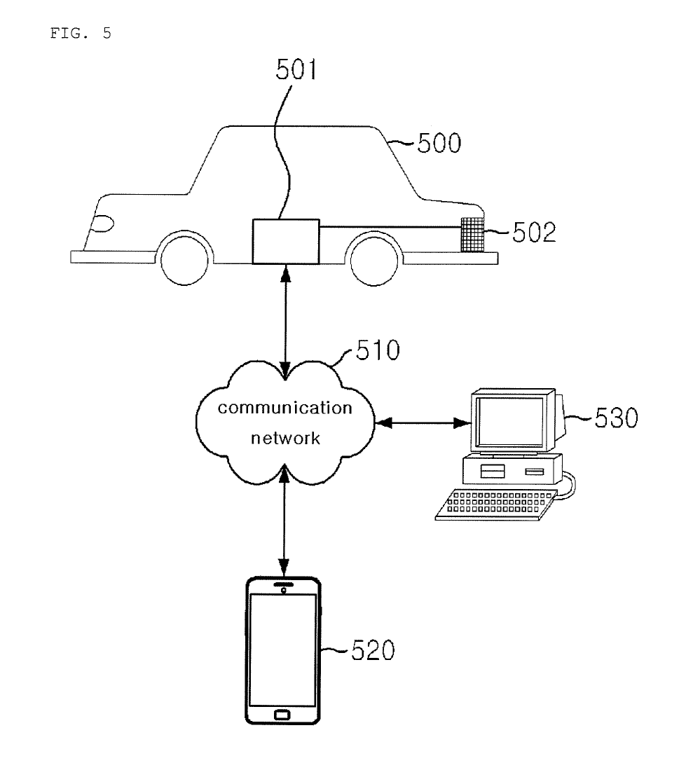

FIG. 3 is a view illustrating another embodiment according to the invention. In FIG. 3, the said selecting means (10) is consisted of the voice recognition device which recognizes the driver's voice, and then outputs it as a data. The said voice recognition device is composed of a microphone (11) to collect the driver's voice and the voice recognition unit (12) which analyzes the voice signal outputted from the microphone (11) and outputs it. Such voice recognition device which recognizes the voice and make it datum, may be implemented in hardware or software, and those skilled in the art also can implement in a various method by using the well known voice recognition technology, so a detailed description thereof will be omitted.

Thus, if the driver speech with voice the name of the desired designs or patterns, i.e., a heart a triangle, or a rectangle which is stored in the control unit (20), the said voice recognition device receives and analyzes it and outputs, and then the said control unit (20) recognizes as that the driver selects the corresponding designs or patterns, and outputs the selected pattern data to the lighting unit (1) when the driver steps the brake pedal, to make the lighting unit (1) to illuminate with the form of selected designs or patterns.

Thus, if the driver speech the name of the desired designs or patterns such as a heart a triangle, or a rectangle through the microphone (11), the voice recognition device receives and analyzes it and outputs to the said control unit (20) to select the corresponding designs or patterns, and then the selected pattern data is displayed on the lighting unit (1) when the driver steps the brake pedal to on the detection switch (2).

Since such variable brake light make it possible for the driver to input the selection signal unlike the first embodiment which the driver input the selection signal by operating the selection switch, it offer a comfortable advantages at easy-to-use. In particular, the selection signal can be simply inputted during driving so that it can be more convenient to use, and there is advantageous that it can prevent from being disturbed the security driving since it is not necessary to view the selection switch for operating it during the driving.

FIG. 4 illustrates the third embodiment according to the invention, wherein it further comprises a GPS (40) which is connected to the said control unit (20) and outputs information such as position and velocity or acceleration of the vehicle.

Then, it is configured such that the said control unit (20) receives the data for velocity and acceleration being outputted from the said GPS (40), and then outputs the data of specific designs or colors to the lighting unit (1) in case that the vehicle is suddenly stopped or traveled at the road of steep slope or sharp curves. At this time, the said data of specific designs or colors being outputted from the control unit (20) may be any one that is selected by the driver or that is preset depending on the situation. In other words, when you stop at emergency, flickering mark such as emergency lamp can be outputted, and when driving at a sharp curves or steep slope, a preset deceleration-induced light can be outputted.

In this case, the measurement sensor (30) of the above-described embodiment may be omitted in this configuration. In addition, in case that the navigation combining a GPS (40) with the map data is available, if there is a specific road condition, i.e., the sharp curve at front of vehicle traveling direction, the said navigation output the data to notify it in advance that the vehicle is entering into the sharp curve, and then the said control unit (20) receives the signal of a navigation, and outputs the data of specific designs or patterns informing hazard to display it at the lighting unit (1).

Thus such configured variable brake light has the advantage that the following driver can prepare ahead by outputting a variety of patterns or designs on the lighting unit (1) automatically with using the data such as acceleration of the GPS (40) vehicle even though the driver does not step on the brake pedal.

At this time, it may be configured such that the said control unit (20) outputs a different patterns or designs which are preset according to the height and position data being outputted from the said GPS (40).

Hereinafter, with reference to FIG. 5 to FIG. 10, the method for controlling the patterns or designs of the above-mentioned variable brake light by using a user terminal according to an embodiment of the present invention is now described.

FIG. 5 is a drawing illustrating a variable brake light control system using user terminal according to example of the present invention. With reference to FIG. 5, a variable brake light control system according to an embodiment of the present invention may be configured such that it comprises a brake light control unit (501) being installed in a vehicle, a communication network (510), and the user terminal including the smart phone (520) and the PC (530).

The user terminal according to one embodiment of the invention includes a wireless communication module which can transmit the patterns of the brake light being inputted by the user the brake light control device (501) of the vehicle (500), and input and output capabilities for communicating with the brake light control device (501) via a communication network (510). At this time, the said user terminal, as described above, may be any digital device which is equipped with a memory means and microprocessor and has computing power, such as a desktop computer including a PC (530), a laptop computer, a workstation, a palmtop computer, a personal digital assistant (PDA), Web pad, as well as a mobile communication terminal including a smart phone (520).

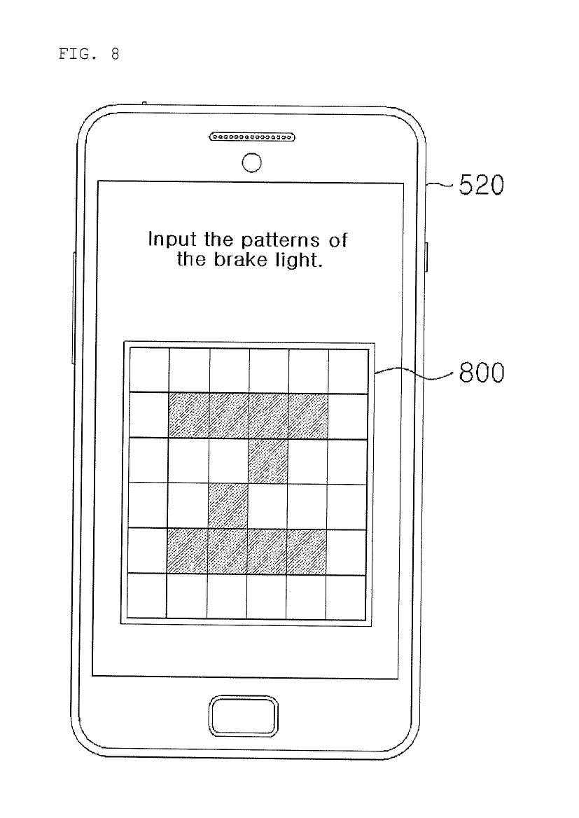

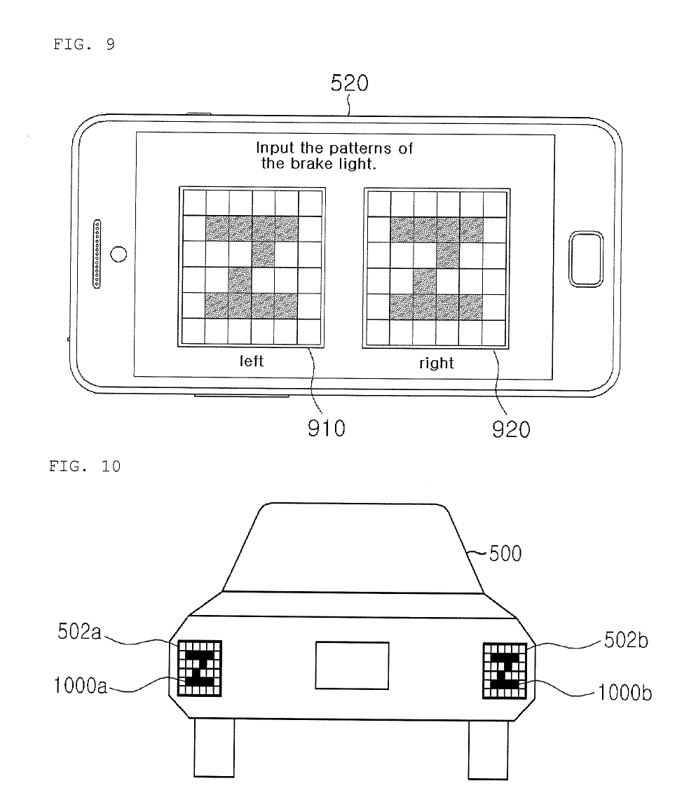

The communication network (510) may be configured with any communication mode including wired and wireless type, and various communication networks such as Personal Area Network (PAN), Local Area Network (LAN), Metropolitan Area Network (MAN), and Wide Area Network (WAN). Further, the said communication network (550) may be the known world wide web(WWW), and can use a wireless transmission technology which is used at short-range communication such as infrared (Infrared Data Assosiation; IrDA) or Bluetooth. Thus, if the designs or patterns to be displayed at the brake light are entered through an application program being installed into the smart phone (520) or PC (530) according to an embodiment of the invention as shown in FIG. 8 and FIG. 9, the said inputted patterns information is transmitted in real time to the brake light control device (501) of the vehicle (500) via the communication network (510). The said brake light control device (501) receives the patterns information being transmitted from the said smart phone (520), and then generates the signal capable of controlling the brake light (502) in response to the said information and transmits it to the brake light (502). The brake light (502) displays the patterns being entered by the user intactly by making each emitting elements (e.g., LED light) constituting the brake light (502) with on/off according to a control signal from the said brake light control device (501).

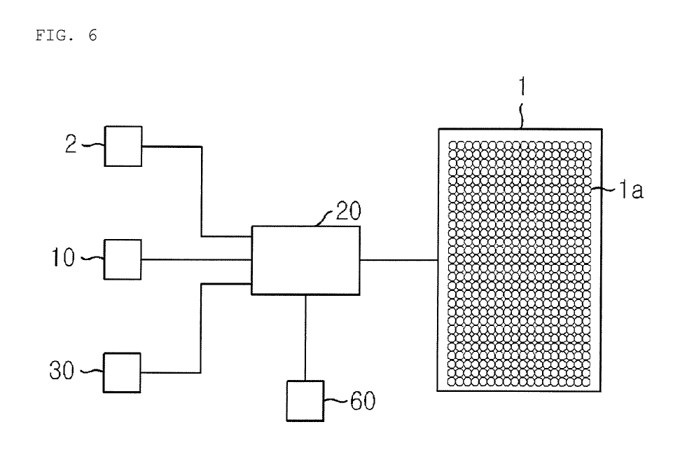

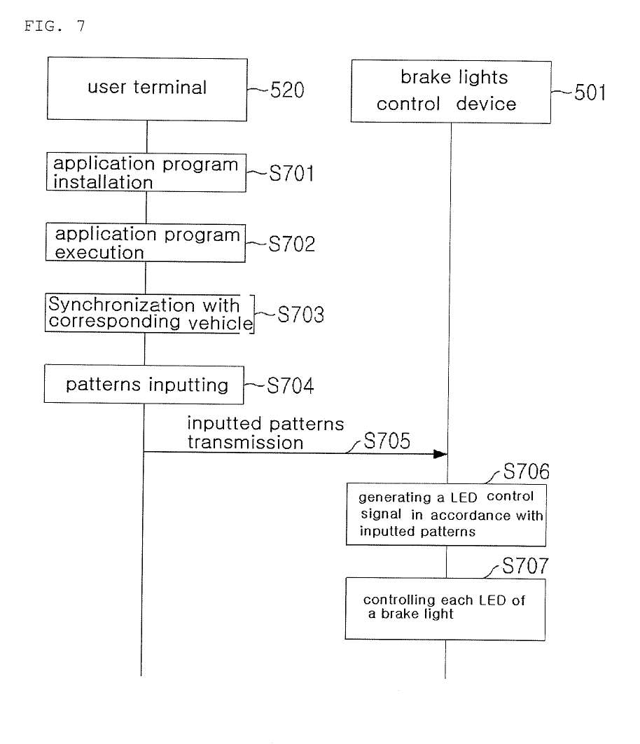

FIG. 6 is a drawing illustrating a detailed configuration of the brake light control device according to example of the present invention. With reference to FIG. 6, the pattern information of the brake light is transmitted via the smart phone (520) and the like as described above in FIG. 5, then the said transmitted pattern information is received via the wireless communication unit (60). Then, the control unit (20) generates the control signal to make each LED (la) of the lighting unit (1) the brake light with on/off according to the said received pattern information and transmits it to the lighting unit (1). At each LED (la) of the lighting unit (1), the corresponding LED is turned on/off by the said control signals, thereby the patterns entered by the smart phone (520) being displayed as it is.

On the other hand, even though it is described at the above that the LED is turned on/off, it is also possible to implement to separate a form with different colors.

FIG. 7 is a flowchart showing the procedure for controlling a variable brake light using user terminal according to example of the present invention. With reference to FIG. 7, the application program to control the brake light is firstly installed at a user terminal (e.g., a smart phone (520)) (S701), and the installed application program is executed (S702). Then, the synchronization with the corresponding vehicle through the said application program is performed (S703).

On the other hand, it is possible to add a process for registering the information of the vehicle which communicates with the said smart phone (520) before the said synchronization process, and add the information of the vehicle automatically over the course of the said synchronization process. For example, it is possible to communicate with the wireless communication unit (60) of brake light control device (501) which is installed in the vehicle (500) located in the close range through the vehicle search function of application program being installed in the smart phone (520), thereby making it possible to search the vehicle (500). In this case, it is also possible to set by automatically receiving the basic information (e.g., models, serial numbers, formatting information of the brake light, etc.) for the corresponding vehicle (500) or to directly input information for a vehicle in application program by the user.

Thus, once the communicable state is accomplished by completing synchronization with the corresponding vehicle, the user inputs the desired patterns at the pattern inputting screen from which the said application program provides (S704). For example, if the form of the brake light is displayed through an application program as shown in FIG. 8 and FIG. 9, the user inputs the desired patterns among the said form of the brake light, thereby the said inputted patterns being transmitted in real time to the brake light control device (501) of the said vehicle. At this time, the inputting method of the said pattern may be to input by touching directly by the user in case of touch screen, or to select one of the preset patterns via various inputting keys, or to select the pattern which is manually produced and stored by the user.

Thus, the transmitted pattern information generates the LED control signal at the control unit (20) of the brake light control device (501) in accordance with the said transmitted pattern (S706) and control each LED of the brake light (S707), thereby the corresponding pattern being displayed at the brake light.

FIGS. 8 and 9 are the drawings showing the brake light pattern inputting image at the smart phone according to example of the present invention. At FIG. 8, if the user inputs a specific pattern (for example, ‘Z’ shaped pattern) among one form of the brake light (800) at a smart phone, the said pattern information is transmitted and then the same shape can be displayed on the both brake light.

On the other hand, as shown in FIG. 9, it is also possible to represent the form of left light (910) and the form of the right light (920) respectively, and the user inputs the patterns which will display on the left light and right light separately, thereby the different pattern being displayed at the left and right brake light.

FIG. 10 is a drawing showing the vehicle rear portion which the pattern inputted via the smart phone is displayed on the brake light according to example of the present invention. Referring to FIG. 10, as shown in FIG. 8, the specific pattern (for example, ‘Z’ shaped pattern) is transmitted, and the said inputted pattern can be reflected and displayed in real time on the brake light (502).

As described above, the present invention is described with the particular embodiment and drawing having the specific elements. However, the disclosed embodiment is merely exemplary, and it should be understood that the present invention may be embodied in many various and alternative forms. Therefore, specific structural and functional details disclosed herein are not to be interpreted as limiting but merely as basis for the claims and as a representative basis for teaching one skilled in the art to variously employ the present invention.

Accordingly, the scope of the present invention is limited to the described embodiment, and the appended claims and any equivalents or variants equivalently ones with claims will belong to the scope of the present invention.

What is claimed is:

1. The variable brake light control system of vehicle which comprises a lighting unit of a brake light being installed on the rear of the vehicle and a detection switch which is connected to the brake pedal and is on when the driver stepping the brake pedal, wherein it comprises;
the lighting unit which is consisted of the LED lamp being consisted by disposing a plurality of LED in accordance with a particular pattern in the said brake light to display a certain design or shape of various forms or patterns;
the user terminal which application program is installed, and a pattern inputting means is provides that can enter the patterns of the brake light by the said installed application program, and then the inputted pattern information of the brake light is transferred via the wireless communication means; and
the brake lights control device which receive the said pattern information from the said user terminal via a wireless communication means, and then generate a control signal which can control an on-off of each LED lamp of the said lighting unit based on the said received pattern information to transmit it to the said lighting unit.

2. The variable brake light control system according to claim 1, wherein it is characterized in that the said user terminal communicates with the brake lights control device in accordance with the execution of the said application program, and receives information of the vehicle from the said the brake lights control device, and then synchronizes it.

3. The variable brake light control system according to claim 1, wherein it is characterized in that the said brake light control device comprises the GPS which outputs the information such as position, velocity or acceleration of the vehicle.

4. The variable brake light control system according to claim 1, wherein it is characterized in that the said brake light control device is further provided measurement sensor for measuring the speed or pressure that the driver stepped on the brake pedal.

5. The method for controlling a variable brake light of vehicle by a brake light control system for vehicle which comprises a lighting unit of a brake light being installed on the rear of the vehicle and a detection switch which is connected to the brake pedal and is on when the driver stepping the brake pedal, wherein it comprises steps of;
providing a pattern inputting means which is capable enter the patterns of the brake light by the application program installed in the user terminal;
transferring the pattern information of the brake light being inputted through the said pattern inputting means to the brake lights control device being installed into the vehicle via wireless communication means;
receiving the said pattern information for the said brake lights control device form the said user terminal via wireless communication means, and generating a control signal which can control an on-off of each LED lamp of the said lighting unit based on the said received pattern information;
transferring the said control signal being generated form the said brake lights control device to the lighting unit; and
being a plurality of LED of to said the lighting unit on-off to the corresponding patterns in accordance with the said control signal.

6. The method for controlling a variable brake light of vehicle according to claim 5, wherein it is characterized in that the said method further comprises step that the said user terminal communicates with the brake lights control device in accordance with the execution of the said application program, and receives information of the vehicle from the said the brake lights control device, and then synchronizes it.

7. The method for controlling a variable brake light of vehicle according to claim 5, wherein it is characterized in that the said brake light control device comprises the GPS which outputs the information such as position, velocity or acceleration of the vehicle.

8. The method for controlling a variable brake light of vehicle according to claim 5, wherein it is characterized in that the said brake light control device is further provided measurement sensor for measuring the speed or pressure that the driver stepped on the brake pedal.
